(19) United States
(12) Patent Application Publication
(10) Pub. No.: US 2006/0215421 A1
(43) Pub. Date: Sep. 28, 2006

(54) Direct type backlight module and display apparatus including the same

(75) Inventors: Chien-Wei Chang, Houli Township (TW); Sheng-Chieh Lung, Yangmei Township (TW); Hung-Ming Yang, Yuanchang Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/208,769

(22) Filed: Aug. 22, 2005

(30) Foreign Application Priority Data
Mar. 22, 2005 (TW) 94108741

(51) Int. Cl. F21V 7/04

(52) U.S. Cl. 362/632; 362/633

(57) ABSTRACT

A direct type backlight module comprises a front panel, a back cover and at least one light source. The back cover comprises an inner surface and an outer surface. The at least one light source is disposed on the inner surface of the back cover and comprises a power line for connecting to the at least one light source and the front panel. The direct type backlight provides a mechanism allowing the direct backlight module to be opened from rear. The direct type backlight prevents interfere between the power line and the front panel via the design of the mechanism. The display apparatus includes the direct type backlight module.

### BACKGROUND

The invention relates to a direct type backlight module and, more particularly, to a display utilizing the direct type backlight module.

Referring to FIG. 1, a conventional backlight module 1 comprises an upper and lower metal shell 11, a diffuser 12, a prism sheet 13, a cold cathode fluorescent lamp 14, a reflector 16, and a circuit board 17. The cold cathode fluorescent lamp 14 must be replaced after long-term use. It is very inconvenient to replace the cold cathode fluorescent lamp 14, because all elements in the backlight module 1 must be detached layer by layer. When detaching the backlight module 1, dust may enter the backlight module 1 and other elements may be broken.

### SUMMARY

The present invention providing a direct type backlight module and a display apparatus including the same.

The backlight module comprises a front panel, a back cover, and at least one light source disposed on the back cover. The back cover comprises an inner surface and an outer surface. The at least one light source is disposed on the inner surface. The at least one light source has a power line electrically connected to the at least one light source and front panel.

An embodiment of the present invention of the backlight module further comprises at least one pivoting element connected to the front panel and the inner surface. The at least one pivoting element is adapted to accommodate the power line.

In another embodiment, the power line passes through the outer surface of the back cover electrically connected to the light source and the front panel.

The display apparatus comprises the described direct type backlight module.

### BRIEF DESCRIPTION OF THE DRAWINGS

The present invention can be more fully understood by reading the subsequent detailed description in conjunction with the examples and references made to the accompanying drawings, wherein:

FIG. 1 is a schematic drawing of a conventional direct type backlight module;

FIG. 2A is a schematic drawing of the first embodiment of the present invention of a backlight module with a cover open;

FIG. 2B is a schematic drawing of the first embodiment of the present invention of a backlight module with a cover closed;

FIG. 3A is a schematic drawing of the second embodiment of the present invention of a backlight module with a cover open;

FIG. 3B is a schematic drawing of the second embodiment of the present invention of a backlight module with a cover closed;

FIG. 4 is a perspective drawing of the second embodiment of the present invention of a backlight module;

FIG. 5 is a schematic drawing of the third embodiment of the present invention of a backlight module.

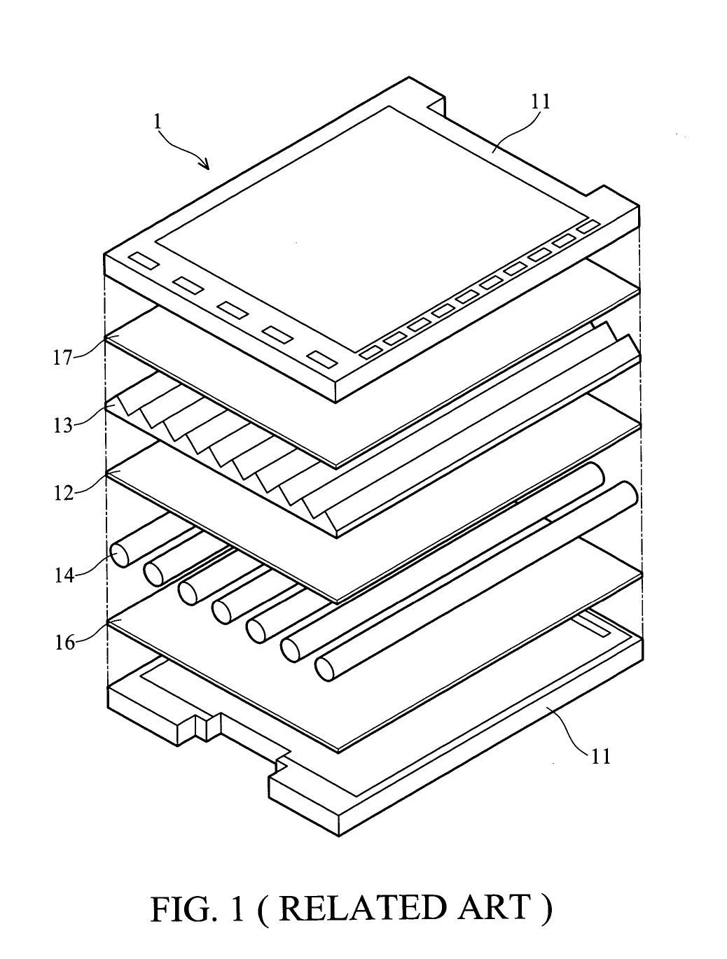

### DETAILED DESCRIPTION

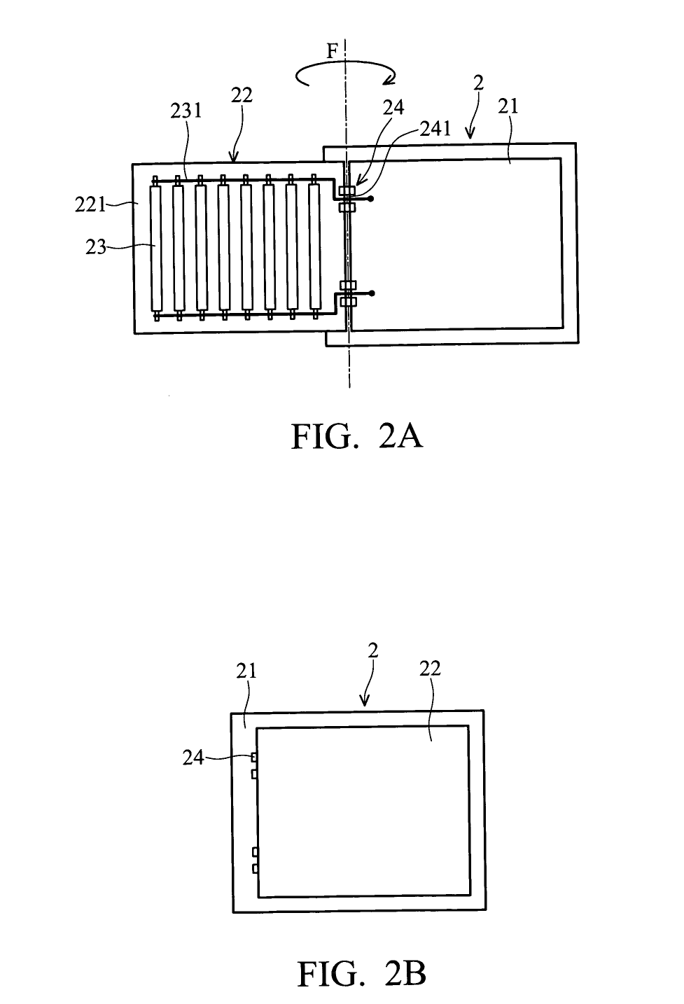

Referring to FIGS. 2A and 2B, a direct type backlight module 2 comprises a front panel 21, a back cover 22, and a plurality of light sources 23. A diffuser, a prism sheet, a reflector, and a circuit board (not shown) are disposed on the front panel 21. The back cover 22 has an inner surface 221 on which a power line 231 is provided and connects the light sources 23 to a circuit board of the front panel 21. The light sources 23 may be cold cathode fluorescent lamps or one or more light-emitting diodes. If the light sources 23 are U-shaped cold cathode fluorescent lamps, the light sources 23 are perpendicular to the longer side of the cover 22 or are parallel to the longer side of the cover 22. The back cover 22 comprises at least one fixing element 223 for fixing to the back cover 22 and the front panel 21. The at least one fixing element 223 may be a screw. The expanding angle between the back cover 22 and the front panel 21. The expanding angle can be range from about 0° to about 180°.

The direct type backlight module 2 further comprises at least one pivoting element 24. The at least one pivoting element 24 is connected to the front panel 21 and the inner surface 221. The at least one pivoting element 24 is adapted to accommodate the power line 231, just like as the at least one pivoting element 24 comprises a space 241.

The light sources 23 disposed on the back cover 22 can be easily replaced. When replacing the light sources 23, the backlight module 2 is not detached layer by layer. The power line 231 is disposed into the space 241 to avoid interference when opening and closing the back cover 22.

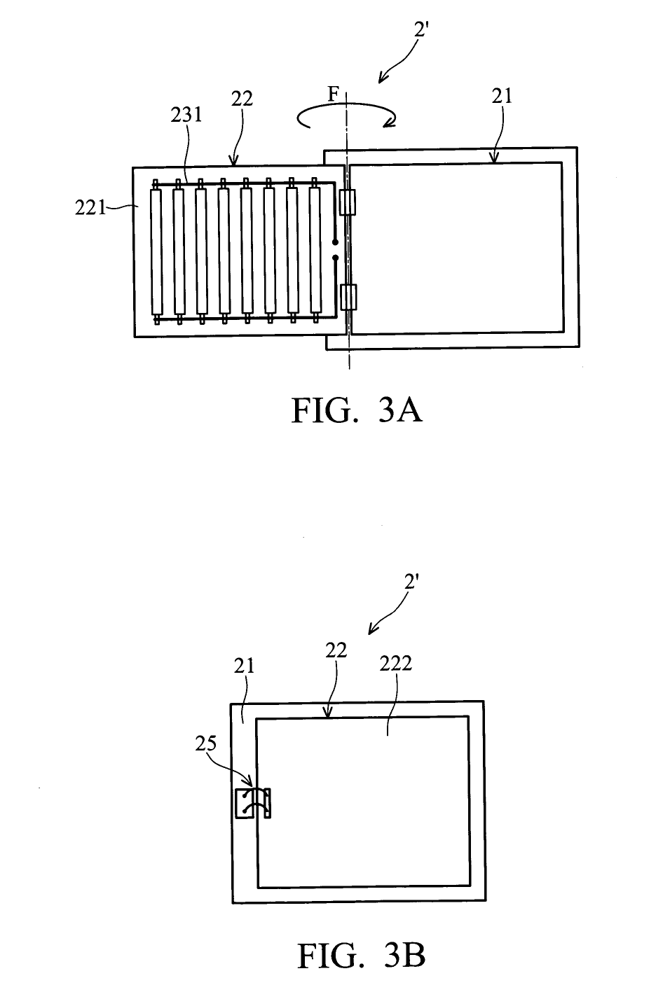

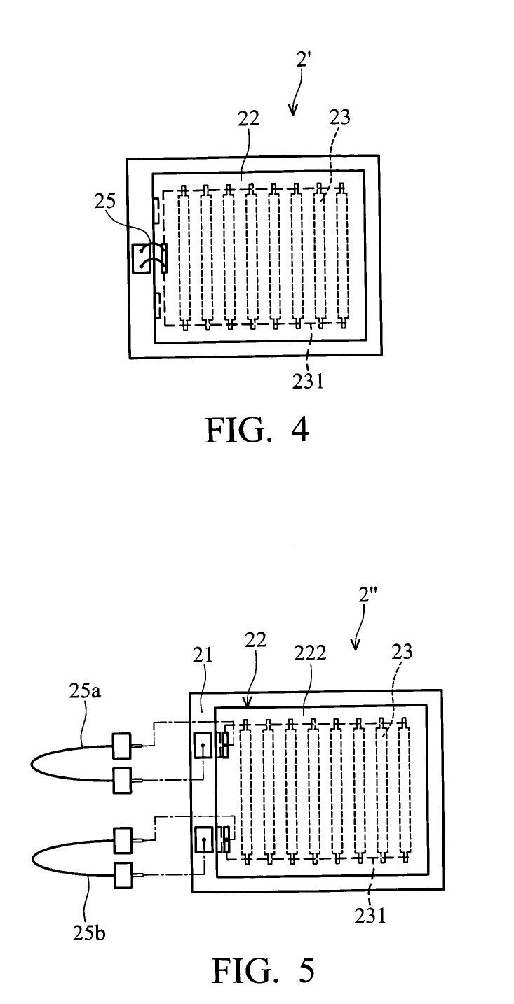

FIGS. 3A, 3B, and 4 illustrate another direct type backlight module 2′ comprising a front panel 21, a back cover 22, a plurality of light sources 23, and a power line 25. A diffuser, a prism sheet, a reflector, and a circuit board (not shown) are disposed on the front panel 21. The back cover 22 comprises an inner surface 221 and an outer surface 222. The light sources 23 comprise a power line 231 disposed on the inner surface 221. The power line 231 electrically connected to the light sources 23. The power line 25 disposed on the outer surface 222 and passes through the outer surface 222 of the back cover 22 electrically connected to the power line 231 and then connects to the front panel 21 and the light sources 23. The light sources 23 disposed on the back cover 22 can be easily replaced. When replacing the light sources 23, the backlight module 2 is not detached layer by layer. Interference between the back cover 22 and the front panel 21 is prevented because the power line 231 connects to the front panel 21 via the power line 25 and the power line 25 connects to the front panel on the outer surface 222.

FIG. 5 illustrates another direct type backlight module 2″ comprising a front panel 21, a back cover 22, a plurality of light sources 23, and two power lines 25a, 25b. A diffuser, a prism sheet, a reflector, and a circuit board (not shown) are disposed on the front panel 21. The back cover 22 comprises an inner surface 221 (FIG. 3 shown) and an outer surface 222. The light sources 23 comprise a power line 231 disposed on the inner surface 221. The power line 231 electrically contacted to the light sources 23. The power line 25a, 25b disposed on the outer surface 222 and passes through the outer surface 222 of the back cover 22 electrically connected to the power line 231 and then connects to the front panel 21 and the light sources 23. The light sources 23 disposed on the back cover 22 can be easily replaced. When replacing the light sources 23, the backlight module 2 is not detached layer by layer. Interference between the cover 22 and the front panel 21 is prevented because the power line 231 connects to the front panel via the power line 25 and the power line 25a, 25b connects to the front panel 21 on the outer surface 222.

While the present invention has been described by way of example and in terms of preferred embodiment, it is to be understood that the present invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

We claim:

1. A direct type backlight module, comprising:
a front panel;
a back cover having an inner surface and an outer surface; and
at least one light source disposed on the inner surface, the at least one light source having a power line electrically connected to the at least one light source and the front panel.

2. The direct type backlight module of claim 1, further comprising at least one pivoting element operatively connected to the front panel and the inner surface, wherein the pivoting element is adapted to accommodate the power line.

3. The direct type backlight module of claim 1, further comprising a power line passes through the outer surface of the back cover electrically connected to the front panel and the at least one light source.

4. The direct type backlight module of claim 1, wherein the at least one light source comprises a cold cathode fluorescent lamp.

5. The direct type backlight module of claim 4, wherein the cold cathode fluorescent lamp is disposed on the back cover and is parallel to the longer side of the back cover.

6. The direct type backlight module of claim 4, wherein the cold cathode fluorescent lamp is disposed on the back cover and is perpendicular to the longer side of the back cover.

7. The direct type backlight module of claim 1, wherein the light source comprises one or more light emitting diodes.

8. The direct type backlight module of claim 1, wherein the light source comprises a U-shaped cold cathode fluorescent lamp.

9. The direct type backlight module of claim 8, the U-shaped cold cathode fluorescent lamp is disposed on the back cover and is parallel to the longer side of the back cover.

10. The direct type backlight module of claim 8, the U-shaped cold cathode fluorescent lamp is disposed on the back cover and is perpendicular to the longer side of the back cover.

11. The direct type backlight module of claim 2, wherein the at least one pivoting element comprises a hinge.

12. The direct type backlight module of claim 1, wherein the back cover comprises at least one fixing element for fixing to the back cover and the front panel.

13. The direct type backlight module of claim 12, wherein the at least one fixing element comprises a screw.

14. The direct type backlight module of claim 1, wherein the expanding angle between the back cover and the front panel ranges from about 0° to about 180°.

15. A display apparatus, comprising the direct type backlight module of claim 1.
